(19) United States
(12) Patent Application Publication
(10) Pub. No.: US 2012/0230224 A1
(43) Pub. Date: Sep. 13, 2012

(54) MOBILE COMMUNICATION SYSTEM, RELAY STATION, AND BASE STATION

(75) Inventors: Hiroaki AMINAKA, Tokyo (JP); Boonsarn PITAKDUMRONGKIJA, Tokyo (JP); Yoshikazu KAKURA, Tokyo (JP)

(73) Assignee: NEC CORPORATION, Tokyo (JP)

(21) Appl. No.: 13/416,664

(22) Filed: Mar. 9, 2012

(30) Foreign Application Priority Data
Mar. 11, 2011 (JP) 2011-054427

(51) Int. Cl. H04W 76/02; H04W 88/08; H04W 88/04

(52) U.S. Cl. 370/255

(57) ABSTRACT

A mobile communication system includes a base station and a relay station. The base station transmits carrier information to the relay station during connection of a first radio link using a first carrier. The carrier information indicates at least one candidate carrier available for performing multi-carrier communication on the first radio link. The relay station transmits, to the base station, request information about a configuration of the first radio link for the at least one candidate carrier indicated by the carrier information. The base station further determines, in response to receiving the request information from the relay station, a second carrier used with the first carrier for the multi-carrier communication.

### INCORPORATION BY REFERENCE

This application is based upon and claims the benefit of priority from Japanese patent application No. 2011-054427, filed on Mar. 11, 2011, the disclosure of which is incorporated herein in its entirety by reference.

### BACKGROUND

1. Technical Field

The present application relates to a carrier selection method that is used in a system including a base station(s) and a relay station(s) belonging to the base station when multi-carrier communication using plural carriers (i.e., carrier waves or carrier wave frequency bands) simultaneously is performed in a backhaul link between a base station and a relay station.

2. Background

In LTE-Advanced (Long Term Evolution Advanced) of 3GPP (3rd Generation Partnership Project), the introduction of relay stations (hereinafter “RNs (Relay Nodes)”) has been examined. Relay stations of LTE-Advanced are shown in 3GPP TR 36.912 V9.2.0 (2010-03), “Feasibility study for Further Advancements for E-UTRA (LTE-Advanced)”, and 3GPP TR 36.806 V9.0.0 (2010-03), “Relay architectures for E-UTRA (LTE-Advanced)”. The RN is one of techniques for increasing the communication speed of mobile stations (hereinafter “UEs (User Equipments)”) located at cell edges and/or for increasing cell areas of base stations (hereinafter “eNBs (Evolved Node Bs)”). The details of the RN architecture examined in 3GPP are shown in 3GPP TR 36.806 V9.0.0 (2010-03).

The outline of a mobile communication system based on the RN architecture disclosed in 3GPP TR 36.806 V9.0.0 (2010-03) is explained hereinafter. FIG. 1 shows a network configuration example when the RN examined in 3GPP is used. A base station (eNB) 91 belongs to a core network (hereinafter “CN”) 4 of a mobile telecommunications carrier. The base station (eNB) 91 creates an eNB cell 10 and relays traffic between a mobile station (UE) 3 and the core network (CN) 4. A relay station (RN) 92 belongs to the base station (eNB) 91 by means of a backhaul link (BL1 in the figure) and also belongs to the core network (CN) 4 via the backhaul link (BL1). The mobile station (UEs) 3 belongs to the base station (eNB) 91 or the relay station (RN) 92 by means of an access link (AL1 in the figure). The relay station (RN) 92 creates an RN cell 20 and relays traffic between the mobile station (UE) 3 and the core network (CN) 4. Details of the backhaul link and the access link are explained later.

There are three types, i.e., type 1, type 1a, and type 1b in the RN examined in 3GPP as shown in 3GPP TR 36.814 V9.0.0 (2010-03), “Further advancements for E-UTRA physical layer aspects”. The RN may support only one of these three types, or may change the operating mode between plural types. Alternatively, different operating modes may be used for different UEs that belong to the same RN. The type-1 RN uses the same carrier (i.e., the same frequency) for the backhaul link and the access link (in-band), and time-divides the radio resources for the backhaul link and the radio resources for the access link. The main purpose of this scheme is to avoid the interference from the access-link transmission to the backhaul-link reception in the RN.

The type-1a RN uses different carriers (i.e., different frequencies) for the backhaul link and the access link (out-band). Therefore, the type-1a RN does not require the time-division for radio resources unlike the type-1 RN, and performs mutually-independent communications between the backhaul link and the access link.

Similarly to the type-1 RN, the type-1b RN uses the same frequency for the backhaul link and the access link. However, the type-1b RN does not time-divide the radio resources. The type-1b RN is used on condition that the interference from the access link transmission to the backhaul link reception is sufficiently suppressed.

In the initial procedure through which a RN belongs to an eNB, the RN transmits RN type information including its own RN type to the eNB. Then, the eNB determines the control method of the backhaul link based on the RN type information received from the RN. More specifically, the eNB determines whether the radio resources of the backhaul link are time-divided or not based on the RN type information.

In the specification of the present application, an eNB having a function of allowing an RN to belong thereto is called “Donor eNB” (hereinafter “DeNB”). An UE that directly belongs to an RN is called “RN-UE”. Further, in the discussion on 3GPP, a demand for supporting multihop RNs in the future is arising. The multihop RN is a technique that makes it possible to connect an additional RN to an RN that already belongs to a DeNB in a cascade configuration. In this specification, in the explanation about the multihop, an RN belonging to a DeNB through a radio interface is called “upper RN” and an RN belonging to the upper RN through a radio interface is called “lower RN” in order to distinguish them from each other.

In this specification, a radio interface between a DeNB and an RN and between an upper RN and a lower RN is called “backhaul link”. Meanwhile, a radio interface between an eNB and an eNB-UE and between an RN and an RN-UE is called “access link”.

Further, in LTE-Advanced of 3GPP, the introduction of Carrier Aggregation (hereinafter “CA”), which is a technique for increasing communication speeds by using a plurality of carriers (i.e., carrier wave frequency bands) simultaneously, has been also examined (see 3GPP TR 36.912 V9.2.0 (2010-03)). Each of the plurality of carriers used simultaneously in the CA is called “Component Carrier” (hereinafter “CC”). The eNB can use a plurality of CCs as communication carriers for a UE performing communication. The CA using a plurality of CCs can be composed of one Primary Cell (hereinafter “PCell”) that constitutes the basis of communication, and at least one Secondary Cell (hereinafter “SCell”) for supplementary use.

The inventors of the present application have made detailed examination on the CC selection method that is used when CA is introduced in the backhaul link. As described previously, in a 3GPP mobile communication system in which an RN is introduced, a DeNB cannot determine the control method of the backhaul link with an RN (i.e., which carrier should be used, and whether the carrier should be time-divided or not) unless its RN type is known. Therefore, in 3GPP, a scheme in which an RN notifies a DeNB of RN type information in the initial procedure thorough which the RN belongs to the DeNB has been examined. Then, the DeNB determines a carrier to be used in the backhaul link based on the RN type information received from the RN, and also determines whether the radio resources of the backhaul link are divided or not. However, this backhaul link control method suffers from a problem when CA is introduced in the backhaul link because this method is based on the premise that only one carrier is used for the backhaul link. That is, the DeNB can be informed of the RN type information of only one carrier (CC) corresponding to the PCell in the initial procedure through which the RN belongs to the DeNB. However, the DeNB cannot be informed of the RN type information of each of at least another candidate carrier (CC) that can be used for the SCell. Therefore, the DeNB cannot determine the RN type of the SCell, and thus possibly cannot appropriately set/control the radio resources of the SCell that are used when multi-carrier communication (CA) is performed. For example, when an RN uses a CC operating in the type 1 for the SCell, interference could occur between the access link and the backhaul link of the RN unless the DeNB sets the radio resource division to this CC. Further, when an RN uses a CC operating in the type 1b for the SCell and the DeNB sets the radio resource division to this CC, losses in the radio resources could occur due to the resource division, thus deteriorating the use efficiency of the radio resources.

Certain embodiments of the present invention provide a mobile communication system, a relay station, a base station, a control method thereof, and a program, capable of, when multi-carrier communication (CA) is introduced in a backhaul link in a mobile communication system including an RN, contributing to both the avoidance of interference between the access link and the backhaul link of an RN and the efficient use of radio resources.

### SUMMARY

According to one embodiment, a mobile communication system includes a base station and a relay station. The relay station is configured to perform a data relay between the base station and a mobile station by using a first radio link connected to the base station and a second radio link connected to the mobile station. The base station is configured to transmit carrier information to the relay station in response to a connection of the first radio link using a first carrier. The carrier information indicates at least one candidate carrier available for performing multi-carrier communication on the first radio link. The relay station is further configured to transmit, to the base station, request information about a configuration of the first radio link for the at least one candidate carrier indicated by the carrier information. The base station is further configured to determine, in response to receiving the request information, a second carrier used with the first carrier for the multi-carrier communication.

According to another embodiment, a relay station includes a radio communication unit and a control unit. The radio communication unit is configured to perform a data relay between a base station and a mobile station by using a first radio link connected to the base station and a second radio link connected to the mobile station. The control unit is configured to transmit, to the base station through the radio communication unit, request information about a configuration of the first radio link for at least one candidate carrier indicated by carrier information. The at least one candidate carrier is available for performing multi-carrier communication on the first radio link. The carrier information is transmitted from the base station in response to a connection of the first radio link using a first carrier.

According to yet another embodiment, a base station includes a radio communication unit and a control unit. The radio communication unit is configured to perform a data transfer with a mobile station connected to a relay station via a first and second radio link. The first radio link is connected between the radio communication unit and the relay station, and the second radio link is connected between the relay station and the mobile station. The control unit is configured to (i) transmit carrier information to the relay station in response to a connection of the first radio link using a first carrier, the carrier information indicating at least one candidate carrier available for performing multi-carrier communication on the first radio link, and (ii) determine, in response to receiving request information about a configuration of the first radio link for the at least one candidate carrier from the relay station, a second carrier used with the first carrier for the multi-carrier communication.

According to each of the above-described embodiments of the present invention, it is possible to provide a mobile communication system, a relay station, a base station, a control method thereof, and a program, capable of, when multi-carrier communication (CA) is introduced in a backhaul link in a mobile communication system including an RN, contributing to both the avoidance of interference between the access link and the backhaul link of an RN and the efficient use of radio resources.

### BRIEF DESCRIPTION OF THE DRAWINGS

FIG. 1 is a block diagram showing a configuration example of a 3GPP mobile communication system including an RN according to background;

FIG. 2 is a block diagram showing a configuration example of a mobile communication system according to a first illustrative embodiment of the present invention;

FIG. 3 is a block diagram showing a configuration example of a base station according to the first illustrative embodiment;

FIG. 4 is a block diagram showing a configuration example of a relay station according to the first illustrative embodiment;

FIG. 5 is a block diagram showing a configuration example of a mobile station according to the first illustrative embodiment;

FIG. 6 is a sequence diagram showing an example of a backhaul link control procedure according to the first illustrative embodiment;

FIG. 7 is a flowchart showing an operation example of a relay station according to the first illustrative embodiment;

FIG. 8 is a flowchart showing an operation example of a DeNB according to the first illustrative embodiment;

FIG. 9 is a sequence diagram showing an example of a backhaul link control procedure according to a second illustrative embodiment of the present invention;

FIG. 10 is a flowchart showing an operation example of a relay station according to the second illustrative embodiment;

FIG. 11 is a flowchart showing an operation example of a DeNB according to the second illustrative embodiment;

FIG. 12 is a sequence diagram showing an example of a backhaul link control procedure according to a third illustrative embodiment of the present invention;

FIG. 13 is a flowchart showing an operation example of a relay station according to the third illustrative embodiment;

FIG. 14 is a flowchart showing an operation example of a DeNB according to the third illustrative embodiment;

FIG. 15 is a sequence diagram showing an example of a backhaul link control procedure according to a fourth illustrative embodiment of the present invention;

FIG. 16 is a flowchart showing an operation example of a relay station according to the fourth illustrative embodiment;

FIG. 17 is a flowchart showing an operation example of a DeNB according to the fourth illustrative embodiment;

FIG. 18 is a sequence diagram showing an example of a backhaul link control procedure according to a fifth illustrative embodiment of the present invention;

FIG. 19 is a flowchart showing an operation example of a relay station according to the fifth illustrative embodiment; and

FIG. 20 is a flowchart showing an operation example of a DeNB according to the fifth illustrative embodiment.

### ILLUSTRATIVE EMBODIMENTS

Specific illustrative embodiments to which the present invention is applied are explained hereinafter in detail with reference to the drawings. The same signs are assigned to the same components throughout the drawings, and duplicate explanation is omitted as appropriate for clarifying the explanation.

### First Illustrative Embodiment

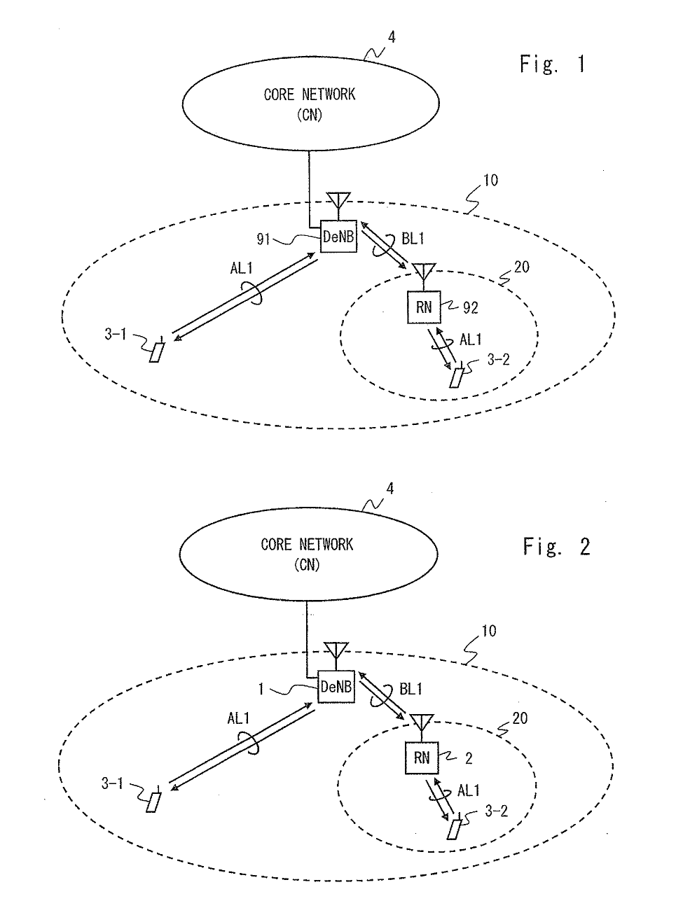

This illustrative embodiment shows an example of backhaul link control in which a base station 1 selects a CC that is used for an SCell when multi-carrier communication (CA) is performed, based on RN type information notified from a relay station 2. A mobile communication system according to this illustrative embodiment is explained on the assumption that the mobile communication system is an FDD (Frequency division Duplex)-OFDMA mobile communication system, more specifically an LTE-Advanced type mobile communication system. FIG. 2 is a block diagram showing a configuration example of a mobile communication system according to this illustrative embodiment. In FIG. 2, the base station 1 belongs to a core network 4 of a mobile telecommunications carrier and relays traffic between a mobile station 3 and the core network 4. The base station 1 is capable of allowing the relay station 2 to belong thereto (i.e., DeNB), and is also capable of allowing the mobile station 3 to belong thereto at the same time.

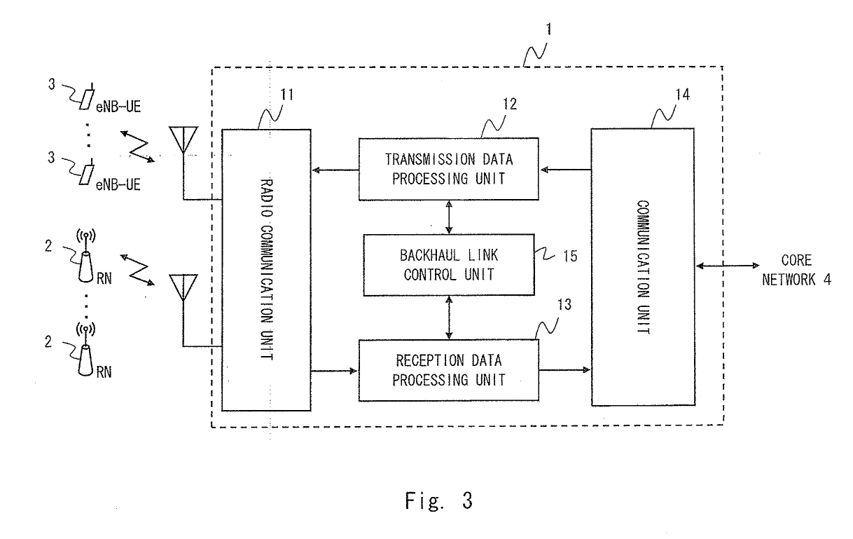

A configuration and an operation of a mobile communication system according to this illustrative embodiment are explained hereinafter in detail. FIG. 3 is a block diagram showing a configuration example of the base station 1. In FIG. 3, a radio communication unit 11 generates a downlink signal by performing various processes including mapping onto resource elements, OFDM signal generation (e.g., IDFT (Inverse Discrete Fourier Transform)), frequency conversion, and signal amplification for a transmission symbol sequence of a physical channel supplied from a transmission data processing unit 12. The generated downlink signal is wirelessly transmitted from an antenna. Further, the radio communication unit 11 receives an uplink signal transmitted from the mobile station 3 or the relay station 2, and restores a reception symbol sequence.

A transmission data processing unit 12 stores data that is obtained from a communication unit 14 and is to be transmitted to the mobile station 3 or the relay station 2 in a buffer that is arranged for each mobile station and each bearer. The processing unit 12 generates a transport channel by performing error correction encoding, rate matching, interleaving, and the like, on data stored in the buffer. Further, the processing unit 12 generates a radio frame by adding control information to the data series of the transport channel. Furthermore, the processing unit 12 generates a transmission symbol sequence for each physical channel by performing scrambling and modulation symbol mapping for the data series of the radio frame.

A reception data processing unit 13 restores received data for each logical channel from a reception symbol sequence supplied from the radio communication unit 11. User traffic data and part of control data included in the obtained reception data are transferred to the core network 4 through the communication unit 14.

A backhaul link control unit 15 controls transmission timing and radio resource allocation relating to communication with the relay station 2 through the backhaul link, and information about the backhaul link. Further, the backhaul link control unit 15 cooperates with the relay station 2 to carry out the setting of the Scell when multi-carrier communication (CA) on the backhaul link is started. Details of the Scell setting procedure are described later.

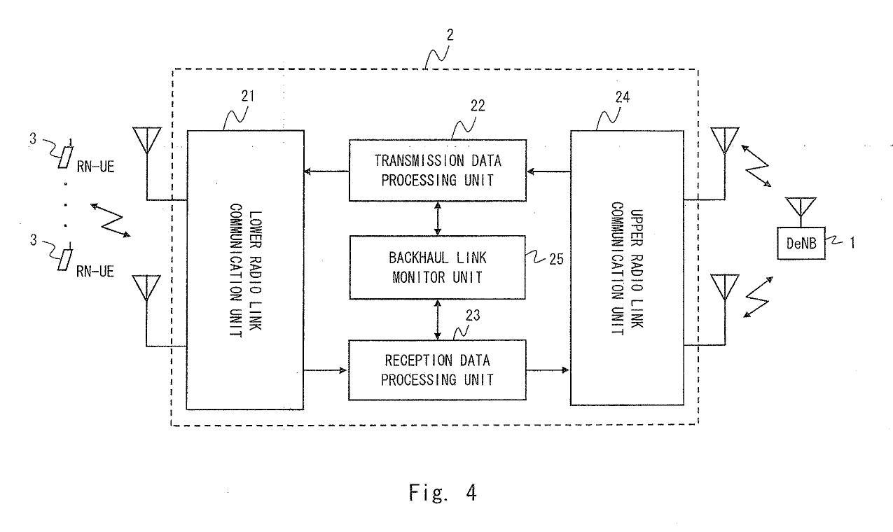

FIG. 4 is a block diagram showing a configuration example of the relay station 2. The relay station 2 has equivalent functions to those of the base station 1 unless specified otherwise. In FIG. 4, a lower radio link communication unit 21 receives an uplink signal transmitted from a mobile station through an antenna. A reception data processing unit 23 has equivalent functions to those of the reception data processing unit 13 of the base station, and obtained received data is transmitted to the base station 1 through an upper radio link communication unit 24.

A transmission data processing unit 22 has similar functions to those of the transmission data processing unit 12 of the base station, and generates a transmission symbol sequence from transmission data that is obtained from the upper radio link communication unit 24 and is to be transmitted to the mobile station. The lower radio link communication unit 21 generates a downlink signal from the transmission symbol sequence and transmits this downlink signal to the mobile station.

A backhaul link monitor unit 25 monitors information about communication with the base station 1 through the backhaul link. Further, the backhaul link monitor unit 25 cooperates with the base station 1 to carry out the setting of the Scell when multi-carrier communication (CA) on the backhaul link is started. Details of the S cell setting procedure are described later.

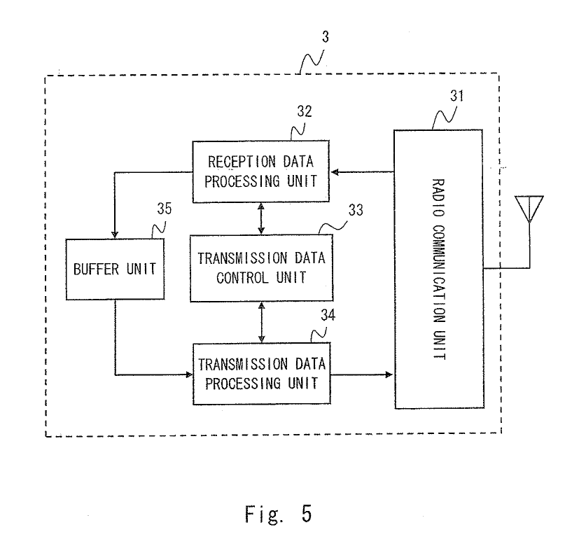

FIG. 5 is a block diagram showing a configuration example of the mobile station 3. A radio communication unit 31 receives a downlink signal through an antenna. A reception data processing unit 32 sends reception data restored from the received downlink signal to a buffer unit 35. Reception data stored in the buffer unit 35 is read out and used according to the purpose. Further, a transmission data control unit 33, a transmission data processing unit 34, and the radio communication unit 31 generate an uplink signal by using transmission data stored in the buffer unit 35, and transmit the generated uplink signal to the base station 1 or the relay station 2.

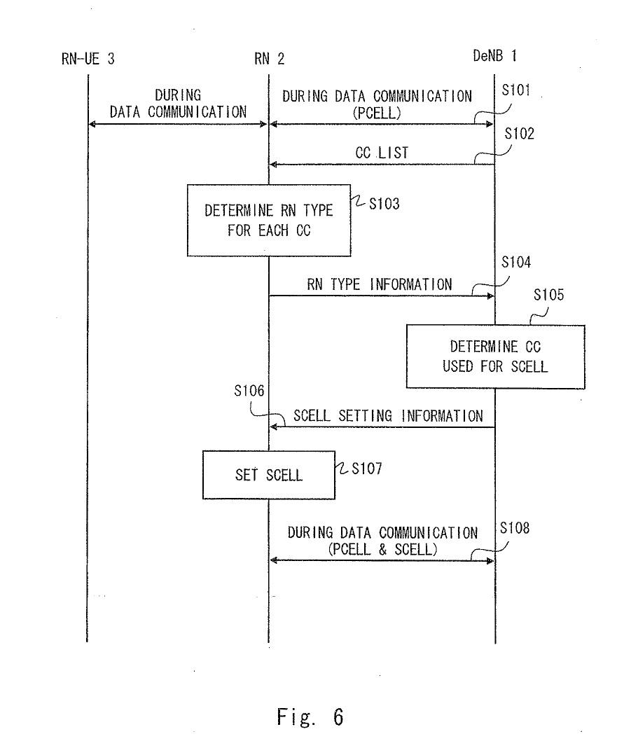

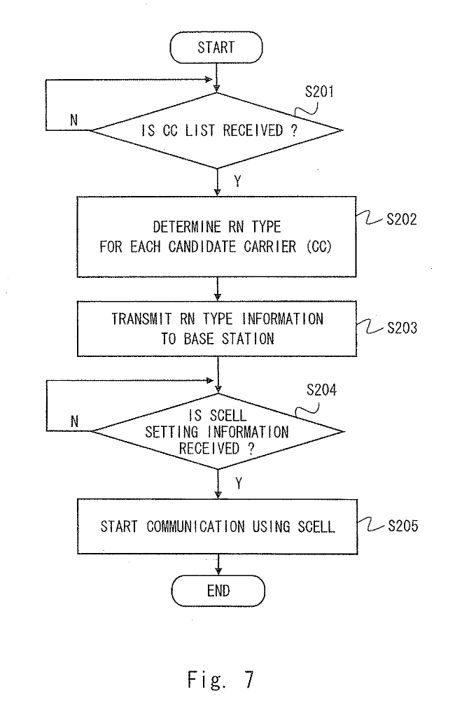

Next, a specific example of a backhaul link control procedure according to this illustrative embodiment is explained hereinafter with reference to FIGS. 6 and 7. FIG. 6 is a sequence diagram showing an example of a control procedure that is performed when multi-carrier communication (CA) on a backhaul link is started. FIG. 6 shows interactions between the base station 1 and the relay station 2. “DeNB”, “RN”, and “RN-UE” written in FIG. 6 correspond to the base station 1, the relay station 2, and the mobile station 3 respectively.

An operation S101 indicates that data communication is performed between the RN-UE and the RN, and between the RN and the DeNB using the PCell. In an operation S102, the DeNB notifies the RN of a CC list at a predetermined timing. The CC list includes information indicating at least one candidate carrier (CC) available for the SCell. The RN determines an RN type for each candidate CC specified in the CC list (operation S103), and notifies the DeNB of RN type information based on the determined RN type (operation S104). The RN type information includes information that is referred to when the base station 1 selects at least one CC from the at least one candidate CC as the CC to be used for the SCell. For example, the RN type information includes, for each candidate CC, at least one of information indicating the necessity/non-necessity of the radio resource division and information indicating an RN type. The DeNB determines which CC is used for the SCell among the at least one candidate CC based on the received RN type information (operation S105). Then, the DeNB notifies the RN of SCell setting information about the CC determined to be used for the SCell (operation S106). The SCell setting information includes, for example, a cell ID, carrier information, and channel setting information. Note that the cell ID is an identifier of the SCell. The carrier information indicates the CC (frequency) to be used for the SCell. Further, the channel setting information includes setting information of channels that are carried through the backhaul link. The RN sets an SCell based on the received SCell setting information (operation S107), and starts communication with the eNB using the SCell (operation S108).

FIG. 7 is a flowchart showing an operation example of the relay station 2 that is performed when multi-carrier communication (CA) on a backhaul link is started. The relay station 2 starts the procedure of FIG. 7 at receiving a CC list from the base station 1 (operation S201).

When a CC list is received (Yes at operation S201), the relay station 2 determines the RN type for each candidate CC (operation S202) and transmits RN type information (including, for each candidate CC, an RN type, necessity/non-necessity of radio resource division, and the like) that is determined based on the determined RN type to the base station 1 (operation S203). The RN type may be determined by comparing the candidate CC with a CC that is currently used or is intended to be used in the access link of the relay station 2. For example, the RN type of a candidate CC that is different from the carrier currently used in the access link may be determined to be “type 1a” that does not require the radio resource division. On the other hand, the RN type of a candidate CC that is the same as the carrier currently used in the access link may be determined to be “type 1” that requires the radio resource division. When no CC list is received (No at operation S201), the relay station 2 returns to the operation S201.

In an operation S204, the relay station 2 determines whether SCell setting information is received from the base station 1 or not. When SCell setting information is received (Yes at operation S204), the relay station 2 sets an SCell by using a CC specified in the received SCell setting information and starts communication by using the SCell (operation S205). When no SCell setting information is received (No at operation S204), the relay station 2 returns to the operation S204 to determine a reception of SCell setting information again.

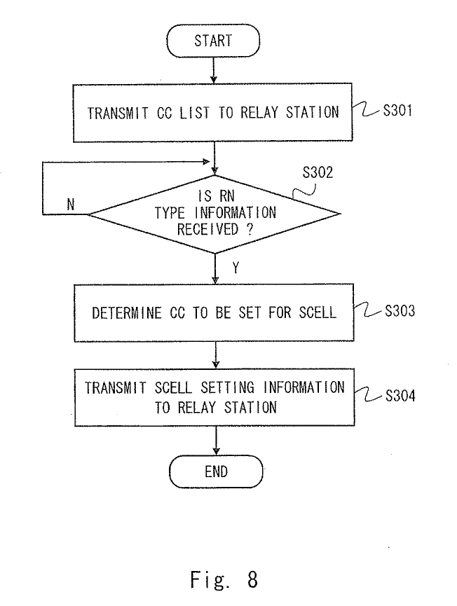

FIG. 8 is a flowchart showing an operation example of the base station 1 that is performed when multi-carrier communication (CA) on a backhaul link is started. The base station 1 starts the procedure of FIG. 8 at transmitting a CC list to the relay station 2 (operation S301).

In an operation S302, the base station 1 determines whether RN type information is received from the relay station 2 or not. When RN type information is received (Yes at operation S302), the base station 1 determines a CC to be used for the SCell based on the received RN type information (operation S303) and notifies the RN of SCell setting information about the determined CC (operation S304). When no RN type information is received (No at operation S302), the base station 1 returns to the operation S302 to determine a reception of RN type information again.

In an operation S303, when the base station 1 determines a CC to be used for the SCell, the base station 1 may select a CC based on a priority of the CC. The CC that does not require the radio resource division (e.g., CC whose RN type is type-1a or type-1b) has a higher priority than the one that does require the radio resource division as the CC to be used for the SCell by referring to the RN type information received from the relay station 2. Further, the base station 1 may take the radio resource usage rate of each CC into consideration in addition to the RN type notified from the relay station 2. Specifically, when the radio resource usage rate of the CC that does not require the radio resource division is higher than a predetermined criterion, the base station 1 may select a CC that requires radio resource division but has a low radio resource usage rate as the CC to be used for the SCell.

Note that the operation of the mobile station 3 is not different from ordinary operations, and therefore its explanation is omitted.

As described above, in this illustrative embodiment, the relay station 2 receives information of at least one candidate carrier available for the SCell for the multi-carrier communication (i.e., CC list) and transmits the RN type information for each candidate carrier (candidate CC) specified in the CC list to the base station 1. The RN type information includes, for each candidate CC, at least one of information indicating the necessity/non-necessity of the radio resource division and information indicating an RN type. Then, the base station 1 determines a CC to be used for the SCell to start multi-carrier communication by referring to the RN type information for each candidate CC notified from the relay station 2. That is, when the base station 1 determines the CC to be used for the SCell, the base station 1 can take the necessity/non-necessity of the radio resource division for each candidate CC into consideration. Therefore, in this illustrative embodiment, it is possible to achieve both the avoidance of interference between the access link and the backhaul link of the relay station 2 and the efficient use of the radio resources when multi-carrier communication (CA) is introduced in the backhaul link.

### Second Illustrative Embodiment

In this illustrative embodiment, the base station 1 sets an SCell for each of at least one candidate carrier available for the SCell in advance. This SCell setting includes the determination of a cell ID, setting on whether resource division is performed or not, setting of channels that is carried through the backhaul link, and so on. Then, the base station 1 transmits the SCell setting information determined for each of the at least one CC to the relay station 2. The transmission of the SCell setting information may be performed by using an RRC message specified in 3GPP TS36.331. The relay station 2 determines an RN type for each of the at least one CC based on the received SCell setting information and sets an SCell for each CC. However, the SCell is not activated (communication is not started) at this time. The relay station 2 notifies the base station 1 of the RN type determined for each of the at least one CC. Then, the base station 1 selects an SCell to be activated (i.e., CC to be used) with consideration given to the RN type for each CC notified from the relay station 2. That is, this illustrative embodiment is different from the above-described first illustrative embodiment in that SCell setting about at least one candidate carrier (CC) is performed in advance by the base station 1 and the relay station 2.

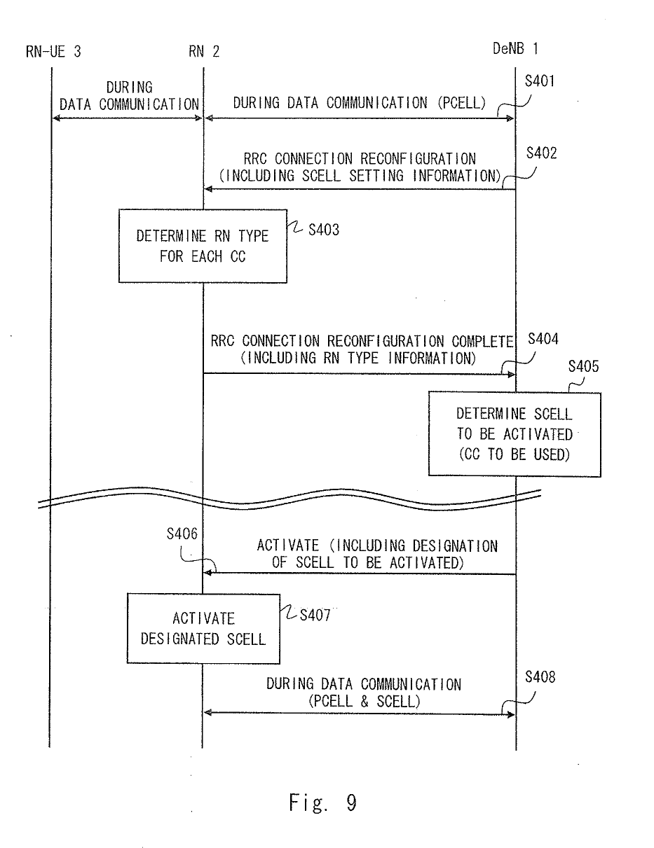

A configuration example of a mobile communication system according to this illustrative embodiment is similar to that of the first illustrative embodiment shown in FIG. 2. A specific example of a backhaul link control procedure according to this illustrative embodiment is explained hereinafter with reference to FIGS. 9 to 11.

FIG. 9 is a sequence diagram showing an example of a control procedure that is performed when multi-carrier communication (CA) on a backhaul link is started. In the figure, “DeNB”, “RN”, and “RN-UE” correspond to the base station 1, the relay station 2, and the mobile station 3 respectively. An operation S401 indicates that data communication is performed between the RN-UE and the RN, and between the RN and the DeNB using the PCell. In an operation S402, the DeNB transmits an RRC Connection Reconfiguration message including SCell setting information to the RN. As described above, this SCell setting information includes setting information for each of at least one candidate carrier (CC) available for the SCell. In an operation S403, the RN determines an RN type for each CC notified by the SCell setting information (operation S403) and transmits RN type information based on the determined RN type to the DeNB (operation S404). In the example shown in FIG. 9, an RRC Connection Reconfiguration Complete message is used for the transmission of the RN type information. The RN type information notified in the operation S404 includes RN type information for each of the at least one candidate carrier (CC) specified in the SCell setting information.

In an operation S405, the DeNB determines which CC, and thus which SCell using that CC should be activated based on the received RN type information. Specifically, the DeNB detects an SCell (i.e., CC) that requires the radio resource division by referring to the RN type information, and thereby determines an SCell to be activated so that both the avoidance of interference between the access link and the backhaul link of the relay station 2 and the efficient use of the radio resources are achieved. Then, the DeNB transmits an Activate message to the RN in order to activate the determined SCell (operation S406). The Activate message includes information for specifying the SCell to be activated (or CC to be used). The transmission timing of the Activate message may be any given timing which is after the SCell to be activated is determined and at which the activation of the SCell becomes necessary. The RN activates the SCell specified in the Activate message in response to the reception of the Activate message (operation S407). As a result, communication using the SCell is started (operation S408).

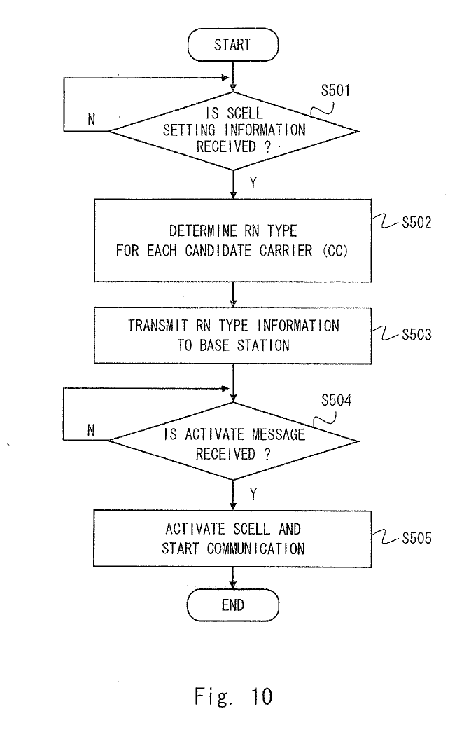

FIG. 10 is a flowchart showing an operation example of the relay station 2 that is performed when multi-carrier communication (CA) on a backhaul link is started. The relay station 2 starts the procedure of FIG. 10 at receiving SCell setting information from the base station 1 (operation S501). As described above, the SCell setting information is transmitted by using, for example, an RRC Connection Reconfiguration message.

When SCell setting information is received (Yes at operation S501), the relay station 2 determines the RN type for each candidate CC specified in the SCell setting information (operation S502) and transmits RN type information (including, for each candidate CC, an RN type, necessity/non-necessity of radio resource division, and the like) determined based on the determined RN type to the base station 1 (operation S503). The RN type information is transmitted by using, for example, an RRC Connection Reconfiguration Complete message. When no SCell setting information is received (No at operation S501), the relay station 2 returns to the operation S501.

In an operation S504, the relay station 2 determines whether or not an Activate message is received from the base station 1. When an Activate message is received (Yes at operation S504), the relay station 2 activates the SCell specified in the Activate message and starts communication by using the SCell (operation S505). When no Activate message is received (No at operation S504), the relay station 2 returns to the operation S504 to determine a reception of an Activate message again.

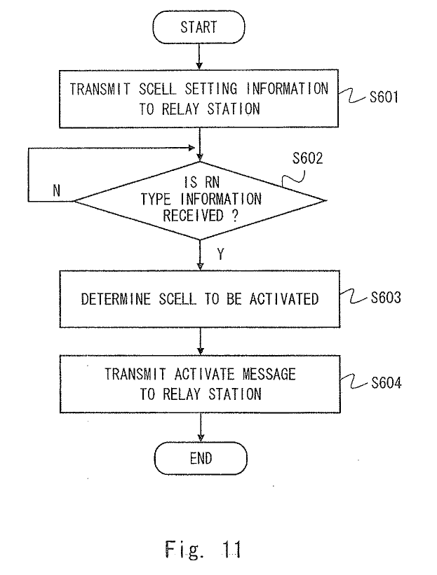

FIG. 11 is a flowchart showing an operation example of the base station 1 that is performed when multi-carrier communication (CA) on a backhaul link is started. The base station 1 starts the procedure of FIG. 11 at transmitting SCell setting information to the relay station 2 by using, for example, an RRC Connection Reconfiguration message (operation S601).

In an operation S602, the base station 1 determines whether or not RN type information is received from the relay station 2. An RRC Connection Reconfiguration Complete message carries the RN type information, for example. When RN type information is received (Yes at operation S602), the base station 1 determines an SCell to be activated based on the received RN type information (operation S603). The SCell determination method in the operation S603 is similar to that of the first illustrative embodiment, and therefore its explanation is omitted. When no RN type information is received (No at operation S602), the base station 1 returns to the operation S602 to determine a reception of RN type information again.

In an operation S604, the base station 1 transmits an Activate message to the relay station 2 in order to activate the SCell (operation S604). The Activate message includes information for specifying the SCell (or CC) determined in the operation S603.

The operation of the mobile station 3 is not different from ordinary operations, and therefore its explanation is omitted.

As described above, in this illustrative embodiment, the relay station 2 receives information of at least one candidate carrier (CC) available for the SCell for the multi-carrier communication (i.e., SCell setting information) and transmits the RN type information for each candidate CC specified in the SCell setting information to the base station 1. The RN type information includes, for each candidate CC, information indicating the necessity/non-necessity of the radio resource division, information indicating an RN type, or the like. Then, the base station 1 determines which of the at least one SCell (i.e., CC) that is set in advance should be activated by referring to the RN type information for each CC notified from the relay station 2. That is, when the base station 1 determines the SCell to be activated (i.e., CC to be used), the base station 1 can take the necessity/non-necessity of the radio resource division for each CC into consideration. Therefore, similarly to the first illustrative embodiment, this illustrative embodiment is possible to achieve both the avoidance of interference between the access link and the backhaul link of the relay station 2 and the efficient use of the radio resources when multi-carrier communication (CA) is introduced in the backhaul link.

### Third Illustrative Embodiment

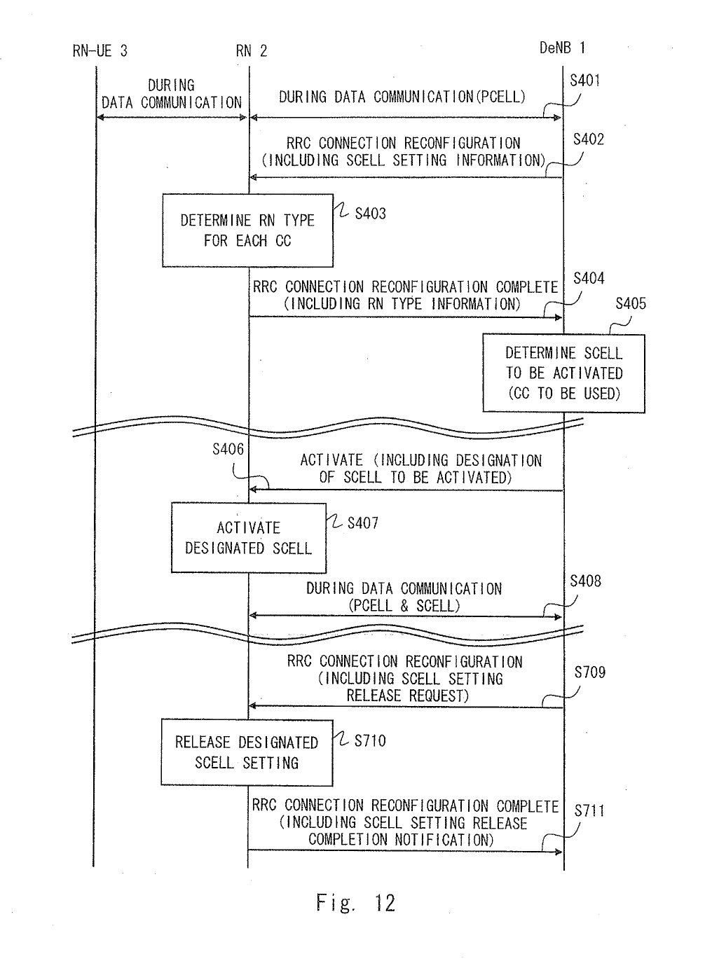

This illustrative embodiment shows a control example in which after the SCell to be activated (i.e., CC to be used) is selected through a similar procedure to that of the second illustrative embodiment, the setting of the SCell that is not activated is released. A configuration example of a mobile communication system according to this illustrative embodiment is similar to that of the first illustrative embodiment shown in FIG. 2. A specific example of a backhaul link control procedure according to this illustrative embodiment is explained hereinafter with reference to FIGS. 12 to 14.

FIG. 12 is a sequence diagram showing an example of a backhaul link control procedure according to this illustrative embodiment. In the figure, “DeNB”, “RN”, and “RN-UE” correspond to the base station 1, the relay station 2, and the mobile station 3 respectively. Operations S401 to S408 in FIG. 12 are similar to the operations assigned with the same numeral symbols, i.e., the operations S401 to S408 in FIG. 9, and therefore their explanation is omitted. In an operation S708 in FIG. 12, after starting communication using the SCell, the DeNB transmits to the RN an SCell setting release request in order to release at least part of the setting of the SCell that is not activated (i.e., CC that is not used) (operation S709). The SCell setting release request is transmitted by using, for example, an RRC Connection Reconfiguration message.

The RN releases the SCell setting relating to the SCell (i.e., CC) specified by the release request (operation S710). The release of the SCell setting may be carried out by the cancellation of the state in which the SCell can be activated in response to the reception of an ACTIVATE message. For example, the release of the SCell setting includes the deletion of the SCell setting information received in the operation S402. Then, the RN transmits a notification of the SCell setting release completion to the DeNB (operation S711). This release completion notification is transmitted by using, for example, a Connection Reconfiguration Complete message.

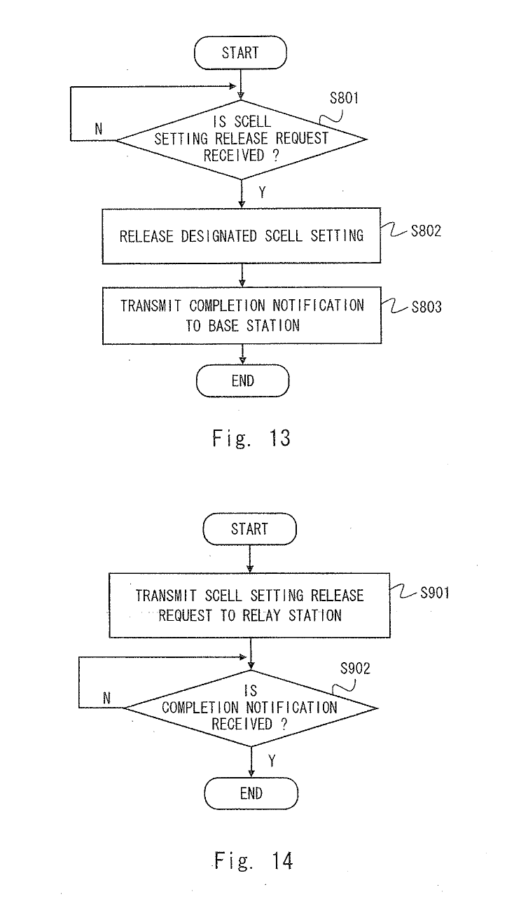

FIG. 13 shows a flowchart showing an operation example of the relay station 2 that is performed when the SCell setting of an un-activated SCell is released. The relay station 2 starts the procedure of FIG. 13 at receiving an SCell setting release request from the base station 1 (operation S801). The SCell setting release request is transmitted by using, for example, an RRC Connection Reconfiguration message.

When an SCell setting release request is received (Yes at operation S801), the relay station 2 releases the corresponding SCell setting (e.g., deletes the SCell setting information) (operation S802). In an operation S803, the relay station 2 transmits an SCell setting release completion notification to the base station 1. This release completion notification is transmitted by using, for example, an RRC Connection Reconfiguration Complete message. When no SCell setting release request is received (No at operation S801), the relay station 2 returns to the operation S801.

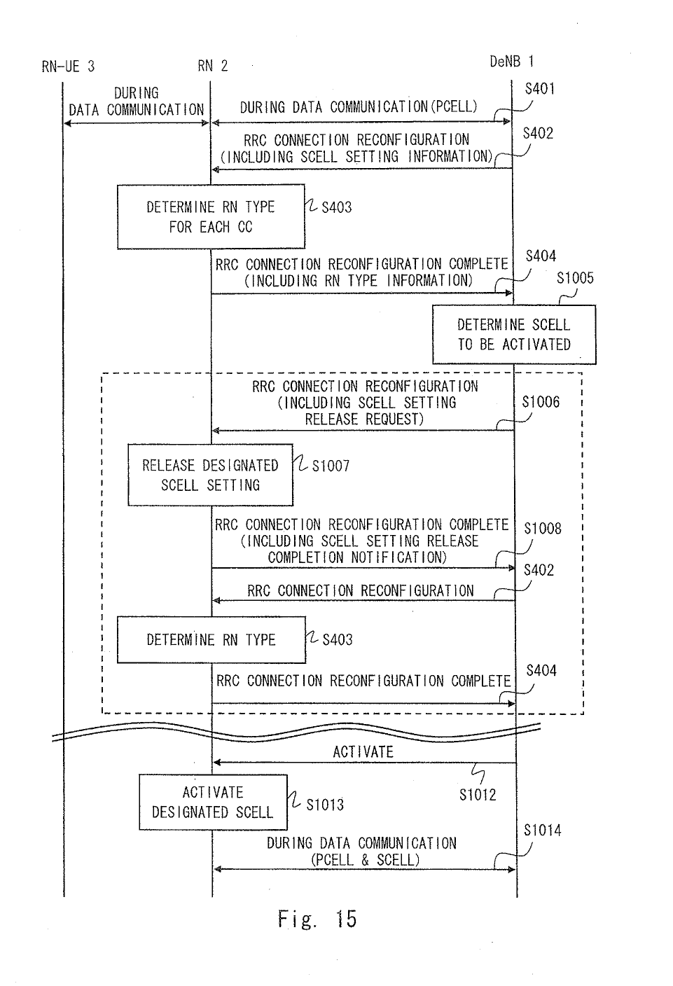

FIG. 14 shows a flowchart showing an operation example of the base station 1 that is performed when the SCell setting of an un-activated SCell is released. The base station 1 starts the procedure of FIG. 14 at transmitting an SCell setting release request to the relay station 2 by using, for example, an RRC Connection Reconfiguration message (operation S901). In an operation S902, the base station 1 determines whether or not an SCell setting release completion notification is received from the relay station 2. The SCell setting release completion notification is included in, for example, an RRC Connection Reconfiguration Complete message. When an SCell setting release completion notification is received (Yes at operation S902), the base station 1 finishes the operation. When no SCell setting release completion notification is received (No at operation S902), the base station 1 returns to the operation S902 for determining a reception of a release completion notification again.

The operation of the mobile station 3 is not different from ordinary operations, and therefore its explanation is omitted.

Similarly to the first and second illustrative embodiments, this illustrative embodiment is possible to achieve both the avoidance of interference between the access link and the backhaul link of the relay station 2 and the efficient use of the radio resources. Further, the base station 1 according to this illustrative embodiment releases the SCell setting of an un-activated SCell(s) after the SCell to be activated is determined. Therefore, this illustrative embodiment can reduce the load required for the management of the SCell setting information by the base station 1 and the relay station 2.

### Fourth Illustrative Embodiment

This illustrative embodiment relates to a modified example of the second illustrative embodiment. Specifically, this illustrative embodiment explains an operation example that is performed when there is no appropriate SCell (i.e., CC) when the base station 1 determines the SCell (CC) to be activated based on RN type information. When there is no appropriate SCell (CC), the base station 1 releases the SCell setting that is set in advance through a similar procedure to that described in the third illustrative embodiment. Then, the base station 1 sets an SCell again by using a different candidate carrier (CC) from the one used for the previous SCell setting.

A configuration example of a mobile communication system according to this illustrative embodiment is similar to that of the first illustrative embodiment shown in FIG. 2. A specific example of a backhaul link control procedure according to this illustrative embodiment is explained hereinafter with reference to FIGS. 15 to 17.

FIG. 15 is a sequence diagram showing an example of a backhaul link control procedure according to the fourth illustrative embodiment. In the figure, “DeNB”, “RN”, and “RN-UE” correspond to the base station 1, the relay station 2, and the mobile station 3 respectively. Operations S401 to S404 in FIG. 15 are similar to the operations assigned with the same numeral symbols, i.e., the operations S401 to S404 in FIG. 9, and therefore their explanation is omitted. In an operation S1005, the DeNB determines which CC, and thus which SCell using that CC should be activated based on the received RN type information. Specifically, the DeNB may detect an SCell (i.e., CC) that requires the radio resource division by referring to the RN type information, and thereby determine an SCell to be activated so that both the avoidance of interference between the access link and the backhaul link of the relay station 2 and the efficient use of the radio resources are achieved. When the DeNB can determine an appropriate CC, i.e., an appropriate SCell based on the RN type information, the DeNB sends an Activate message to the RN in order to activate the determined SCell (operation S1012). The RN activates the SCell specified in the Activate message in response to the reception of the Activate message (operation S1103). As a result, communication using the SCell is started (operation S1104). That is, the operations S1012 to S1014 are similar to the operations S406 to S408 in FIG. 9.

In contrast to this, when the DeNB cannot determine any appropriate CC, i.e., any appropriate SCell based on the RN type information, the DeNB and the RN perform operations S1006 to S1008 and then repeat the operations 5402 to S404 again. In the operation S1006, the DeNB transmits an SCell setting release request to the RN. This release request includes a release request of at least one of the SCell setting that is set in advance in the operation S402. The SCell setting release request is transmitted by using, for example, an RRC Connection Reconfiguration message. The RN releases the SCell setting specified by the release request (operation S1007). Then, the RN transmits a notification of the SCell setting release completion to the DeNB (operation S1008). This release completion notification is transmitted by using, for example, an RRC Connection Reconfiguration Complete message. After that, the DeNB and the RN repeat the operation of the operations 5402 to 5404 and thereby set a new SCell by using a different candidate carrier (CC) from the one used for the previous SCell setting.

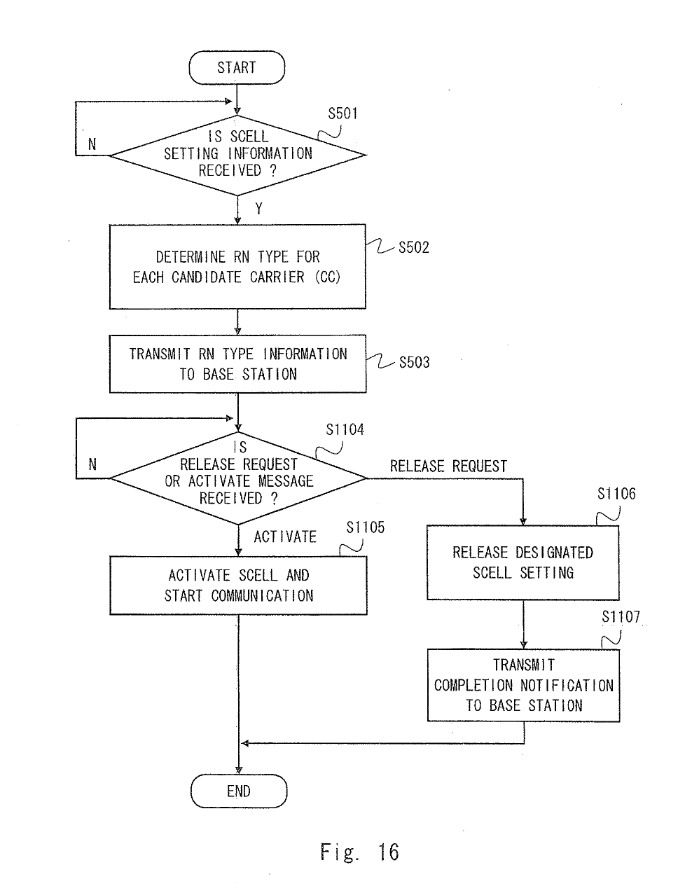

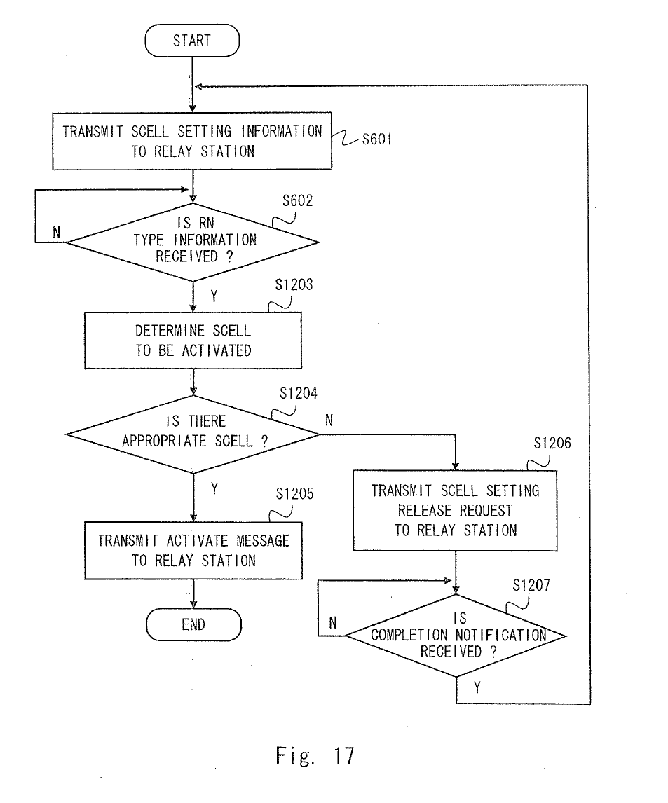

FIG. 16 is a flowchart showing an operation example of the relay station 2 that is performed when backhaul link control according to this illustrative embodiment is performed. The relay station 2 starts the procedure of FIG. 16 at receiving SCell setting information from the base station 1 (operation S501). The SCell setting information is transmitted by using, for example, an RRC Connection Reconfiguration message. Note that operations S501 to S503 in FIG. 16 are similar to the operations assigned with the same numeral symbols, i.e., the operations S501 to S503 in FIG. 10, and therefore their explanation is omitted.

In an operation S1104, the relay station 2 determines whether an SCell setting release request or an Activate message is received from the base station 1 or not. The SCell setting release request is transmitted by using, for example, an RRC Connection Reconfiguration message. When neither the SCell setting release request nor the Activate message is received (No at operation S1104), the relay station 2 returns to the operation S1104 in which the relay station 2 waits for the reception of an SCell setting release request and an Activate message again. When an Activate message is received at operation S1104, the relay station 2 activates the SCell specified in the Activate message and starts communication by using the SCell (operation S1105). When an SCell setting release request is received at operation S1104, the relay station 2 releases the corresponding SCell setting (e.g., deletes the SCell setting information) (operation S1106). In an operation S1107, the relay station 2 transmits an SCell setting release completion notification to the base station 1. This release completion notification is transmitted by using, for example, an RRC Connection Reconfiguration Complete message.

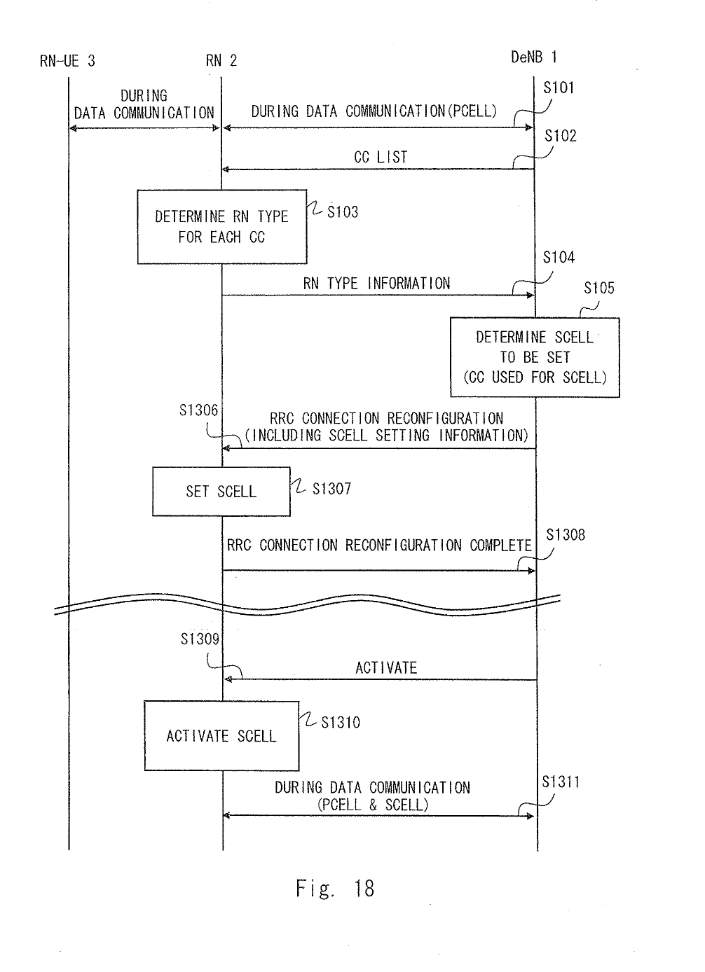

FIG. 17 is a flowchart showing an operation example of the base station 1 that is performed when backhaul link control according to this illustrative embodiment is performed. The base station 1 starts the procedure of FIG. 17 at transmitting SCell setting information to the relay station 2 by using, for example, an RRC Connection Reconfiguration message (operation S601). Note that operations S601 and S602 in FIG. 17 are similar to the operations assigned with the same numeral symbols, i.e., the operations S601 and S602 in FIG. 11, and therefore their explanation is omitted.

In an operation S1203, the base station 1 determines an SCell to be activated based on the RN type information received from the relay station 2. Note that the SCell determination method in the operation S1203 is similar to that of the first illustrative embodiment, and therefore its explanation is omitted. When an appropriate SCell is determined in the operation S1203 (Yes at operation S1204), the base station 1 transmits an Activate message to the relay station 2 in order to activate the SCell and the finishes the procedure shown in FIG. 17 (operation S1205).

On the other hand, as a result of the consideration of the RN type information, the base station 1 determines that there is no appropriate SCell to be activated (No at operation S1204), the base station 1 transmits an SCell setting release request to the relay station 2 by using, for example, an RRC Connection Reconfiguration message (operation S1206). In an operation S1207, the base station 1 determines whether or not an SCell setting release completion notification is received from the relay station 2. The SCell setting release completion notification is included in, for example, an RRC Connection Reconfiguration Complete message. When an SCell setting release completion notification is received (Yes at operation S1207), the base station 1 returns to the operation S601 and transmits SCell setting information about a different candidate carrier (CC) from the one used for the previous SCell setting. When no SCell setting release completion notification is received (No at operation S1207), the base station 1 returns to the operation S1207 to determine a reception of a release completion notification again.

The operation of the mobile station 3 is not different from ordinary operations, and therefore its explanation is omitted.

Similarly to the first and second illustrative embodiments, this illustrative embodiment is possible to achieve both the avoidance of interference between the access link and the backhaul link of the relay station 2 and the efficient use of the radio resources. Further, the base station 1 according to this illustrative embodiment releases the SCell setting of an un-activated SCell(s) when it is determined that there is no appropriate SCell to be activated. Therefore, this illustrative embodiment can reduce the load required for the management of the SCell setting information by the base station 1 and the relay station 2.

### Fifth Illustrative Embodiment

This illustrative embodiment explains a specific example of the above-described first illustrative embodiment. That is, in this illustrative embodiment, the base station 1 transmits information of at least one candidate carrier available for the SCell (i.e., CC list) to the relay station 2 prior to the SCell setting. The relay station 2 determines RN type information for each candidate CC included in the CC list and transmits the determined RN type information to the base station 1. Then, the base station 1 requests the relay station 2 to sets an SCell by using a CC that is selected from the at least one candidate CC based on the RN type information.

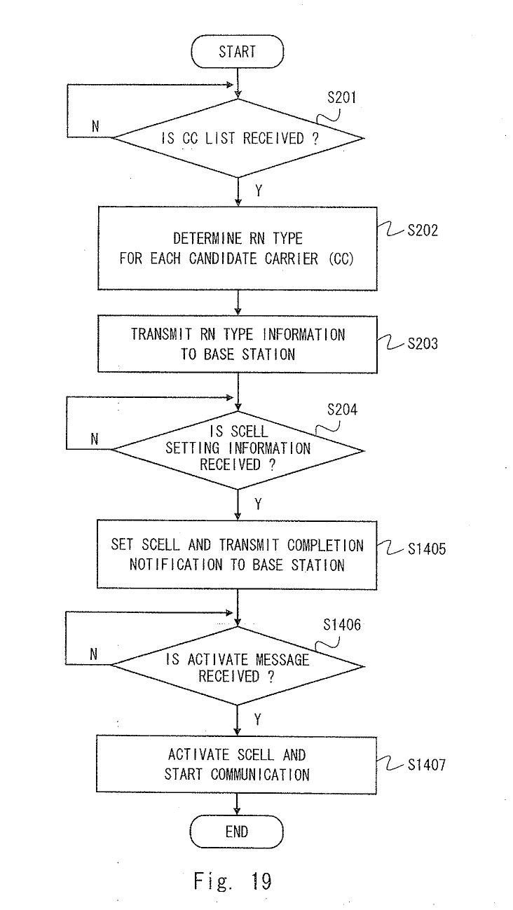

A configuration example of a mobile communication system according to this illustrative embodiment is similar to that of the first illustrative embodiment shown in FIG. 2. A specific example of a backhaul link control procedure according to this illustrative embodiment is explained hereinafter with reference to FIGS. 18 to 20.

FIG. 18 is a sequence diagram showing an example of a control procedure that is performed when multi-carrier communication (CA) on a backhaul link is started. In the figure, “DeNB”, “RN”, and “RN-UE” correspond to the base station 1, the relay station 2, and the mobile station 3 respectively. Operations S101 to S105 in FIG. 18 are similar to the operations assigned with the same numeral symbols, i.e., the operations S101 to S105 in FIG. 6, and therefore their explanation is omitted.

In an operation S1306, the DeNB transmits SCell setting information about the CC that is determined to be used for the SCell based on the RN type information to the RN. In the example shown in FIG. 18, the SCell setting information is transmitted by using an RRC Connection Reconfiguration message. The SCell setting information transmitted in the operation S1306 may include setting information of a plurality of SCells (i.e., a plurality of CCs).

The RN sets an SCell based on the received SCell setting information (operation S1307). In an operation S1308, the RN transmits a notification indicating SCell setting completion to the DeNB. This SCell setting completion notification may include RN type information. In the example shown in FIG. 18, the SCell setting completion notification is transmitted by using an RRC Connection Reconfiguration Complete message.

The operations S1309 to S1311 are similar to the operations S406 to S408 in FIG. 9. That is, in the operation S1309, the DeNB transits an Activate message to the RN in order to activate the SCell. The Activate message includes information for specifying the SCell to be activated (or CC to be used). The transmission timing of the Activate message may be any given timing at which the activation of the SCell becomes necessary. The RN activates the SCell specified in the Activate message in response to the reception of the Activate message (operation S1310). As a result, communication using the SCell is started (operation S1311).

FIG. 19 is a flowchart showing an operation example of the relay station 2 that is performed when multi-carrier communication (CA) on a backhaul link is started. The relay station 2 starts the procedure of FIG. 19 at receiving a CC list from the base station 1 (operation S201). Operations S201 to S204 in FIG. 19 are similar to the operations assigned with the same numeral symbols, i.e., the operations S201 to S204 in FIG. 7, and therefore their explanation is omitted.

In an operation S1405 in FIG. 19, the relay station 2 sets an SCell in accordance with the SCell setting information received from the base station 1 and sends an SCell setting completion notification to the base station 1. In an operation S1406, the relay station 2 determines whether or not an Activate message is received from the base station 1. When an Activate message is received (Yes at operation S1406), the relay station 2 activates the SCell specified in the Activate message and starts communication by using the SCell (operation S1407). When no Activate message is received (No at operation S1406), the relay station 2 returns to the operation S1406 to determine a reception of an Activate message again.

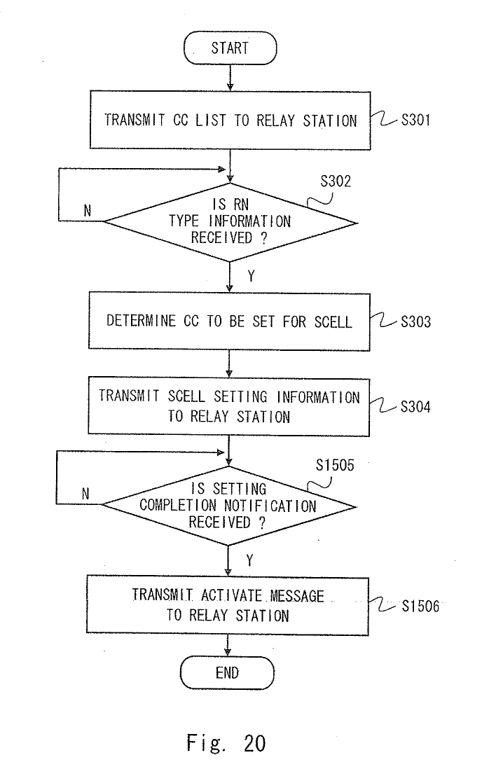

FIG. 20 is a flowchart showing an operation example of the base station 1 that is performed when multi-carrier communication (CA) on a backhaul link is started. The base station 1 starts the procedure of FIG. 20 at transmitting a CC list to the relay station 2 (operation S301). Operations S301 to S304 in FIG. 20 are similar to the operations assigned with the same numeral symbols, i.e., the operations S301 to S304 in FIG. 8, and therefore their explanation is omitted.

In an operation S1505, the base station 1 determines whether or not an SCell setting completion notification is received from the relay station 2. The SCell setting completion notification is included in, for example, an RRC Connection Reconfiguration Complete message. When no setting completion notification is received (No at operation S1505), the base station 1 returns to the operation S1505 to determine a reception of a setting completion notification again.

In an operation S1506, the base station 1 transmits an Activate message to the relay station 2 in order to activate the SCell. The Activate message includes information for specifying the SCell to be activated (or CC to be used).

The operation of the mobile station 3 is not different from ordinary operations, and therefore its explanation is omitted.

Similarly to the above-described first illustrative embodiment, this illustrative embodiment is possible to achieve both the avoidance of interference between the access link and the backhaul link of the relay station 2 and the efficient use of the radio resources when multi-carrier communication (CA) is introduced in the backhaul link.

### Other Illustrative Embodiments

In the above-described first to fifth illustrative embodiments, examples in which the present invention is applied to an LTE-Advanced-type mobile communication system are explained. However, the application of the present invention is not limited to LTE-Advanced-type mobile communication systems. That is, the present invention can be widely applied to mobile communication systems which include a relay station and in which multi-carrier communication is used in a backhaul link between a base station and a relay station.

Any of the processes of the base station 1 and the relay station 2, as described in the above-described first to fifth illustrative embodiments, that are performed when multi-carrier communication (CA) on a backhaul link is started may be implemented by using a semiconductor processing device such as an ASIC (Application Specific Integrated Circuit) or a DSP (Digital Signal Processor). Alternatively, these processes may be implemented by causing a computer such as a microprocessor to execute a program. Specifically, a program including instructions to cause a computer to execute an algorithm shown in at least one of FIGS. 7, 8, 10, 11, 13, 14, 16, 17, 19 and 20 may be prepared and provided to a computer.

This program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or radio communication path.

Further, the first to fifth illustrative embodiments according to the invention can be combined as desired. Further, the present invention is not limited to the above-described illustrative embodiments, and needless to say, various modifications can be made without departing from the spirit and scope of the present invention described above.

For example, the whole or part of the illustrative embodiments disclosed above can be described as, but not limited to, the following supplementary notes.

### (Supplementary Note 1)

A mobile communication system including:

a base station; and

a relay station configured to perform a data relay between the base station and a mobile station by using a first radio link connected to the base station and a second radio link connected to the mobile station, in which

the base station is configured to transmit carrier information to the relay station when the first radio link is in connection using a first carrier, the carrier information indicating at least one candidate carrier available for performing multi-carrier communication on the first radio link,

the relay station is further configured to transmit, to the base station, request information about a configuration of the first radio link for each of the at least one candidate carrier indicated by the carrier information, and

the base station is further configured to determine, based on the request information, a second carrier used with the first carrier for the multi-carrier communication.

### (Supplementary Note 2)

The mobile communication system according to Supplementary note 1, in which the request information includes information for determining whether or not radio resource division is necessary when each of the at least one candidate carrier is used for the multi-carrier communication.

### (Supplementary Note 3)

The mobile communication system according to Supplementary note 2, in which the information for determining whether or not the radio resource division is necessary includes information indicating an operation type of the relay station.

### (Supplementary Note 4)

The mobile communication system according to Supplementary note 2 or 3, in which the base station determines, as the second carrier, a candidate carrier that does not require the radio resource division preferentially among the at least one candidate carrier.

### (Supplementary Note 5)

The mobile communication system according to any one of Supplementary notes 2 to 4, in which the base station determines, as the second carrier, a candidate carrier which does not require the radio resource division and whose radio resource usage ratio is lower than a predetermined reference level among the at least one candidate carrier.

### (Supplementary Note 6)

The mobile communication system according to any one of Supplementary notes 1 to 5, in which the carrier information is transmitted from the base station to the relay station prior to a start of the multi-carrier communication and is included in setting information used for setting by the relay station to start the multi-carrier communication.

### (Supplementary Note 7)

The mobile communication system according to Supplementary note 6, in which

the base station is further configured to transmit an activation request for communication using the second carrier to the relay station, and

the relay station is further configured to activate the communication using the second carrier by using communication setting corresponding to the second carrier indicated in the activation request among communication setting of the at least one candidate carrier hold in advance based on the setting information.

### (Supplementary Note 8)

The mobile communication system according to Supplementary note 7, in which

the base station is further configured to transmit to the relay station a release request for requesting a release of communication setting of each of the candidate carrier except the second carrier, and the relay station is further configured to release communication setting of each of the candidate carrier except the second carrier in response to the release request.

### (Supplementary Note 9)

The mobile communication system according to Supplementary note 6, in which the base station is further configured to, in response to a situation that the second carrier cannot be determined from the at least one candidate carrier, request the relay station to release communication setting of the at least one candidate carrier and transmit to the relay station the setting information including carrier information indicating a new carrier different from the at least one candidate carrier.

### (Supplementary Note 10)

The mobile communication system according to any one of Supplementary notes 1 to 5, in which

the base station is further configured to transmit setting information about the second carrier to the relay station, and

the relay station is further configured to perform setting to start the multi-carrier communication using the second carrier by referring to the setting information.

### (Supplementary Note 11)

A relay station including:

a radio communication unit configured to perform a data relay between a base station and a mobile station by using a first radio link connected to the base station and a second radio link connected to the mobile station; and

a control unit configured to transmit, to the base station through the radio communication unit, request information about a configuration of the first radio link for each of at least one candidate carrier indicated by carrier information, the at least one candidate carrier being available for performing multi-carrier communication on the first radio link, the carrier information being transmitted from the base station when the first radio link is in connection using a first carrier.

### (Supplementary Note 12)

The relay station according to Supplementary note 11, in which the request information includes information for determining whether or not radio resource division is necessary when each of the at least one candidate carrier is used for the multi-carrier communication.

### (Supplementary Note 13)

The relay station according to Supplementary note 12, in which the information for determining whether or not the radio resource division is necessary includes information indicating an operation type of the relay station.

### (Supplementary Note 14)

A base station including:

a radio communication unit configured to perform a data transfer with a mobile station connected to a relay station via a first and second radio link, the first radio link being connected between the radio communication unit and the relay station, the second radio link being connected between the relay station and the mobile station; and

a control unit configured to (i) transmit carrier information to the relay station when the first radio link is in connection using a first carrier, the carrier information indicating at least one candidate carrier available for performing multi-carrier communication on the first radio link, (ii) receive request information about a configuration of the first radio link for each of the at least one candidate carrier from the relay station, and (iii) determine, based on the request information, a second carrier used with the first carrier for the multi-carrier communication.

### (Supplementary Note 15)

The base station according to Supplementary note 14, in which the request information includes information for determining whether or not radio resource division is necessary when each of the at least one candidate carrier is used for the multi-carrier communication.

### (Supplementary Note 16)

The base station according to Supplementary note 15, in which the information for determining whether or not the radio resource division is necessary includes information indicating an operation type of the relay station.

### (Supplementary Note 17)

The base station according to Supplementary note 15 or 16, in which the control unit determines, as the second carrier, a candidate carrier that does not require the radio resource division preferentially among the at least one candidate carrier.

### (Supplementary Note 18)

The base station according to any one of Supplementary notes 15 to 17, in which the control unit determines, as the second carrier, a candidate carrier which does not require the radio resource division and whose radio resource usage ratio is lower than a predetermined reference level among the at least one candidate carrier.

### (Supplementary Note 19)

The base station according to any one of Supplementary notes 14 to 18, in which the carrier information is transmitted from the base station to the relay station prior to a start of the multi-carrier communication and is included in setting information used for setting by the relay station to start the multi-carrier communication.

(Supplementary note 20)

A control method of a relay station that performs a data relay between a base station and a mobile station by using a first radio link connected to the base station and a second radio link connected to the mobile station, the method including:

receiving carrier information from the base station through a radio communication unit of the relay station when the first radio link is in connection using a first carrier, the carrier information indicating at least one candidate carrier available for performing multi-carrier communication on the first radio link; and

transmitting, to the base station through the radio communication unit, request information about a configuration of the first radio link for each of the at least one candidate carrier by referring to the carrier information.

### (Supplementary Note 21)

The method according to Supplementary note 20, in which the request information includes information for determining whether or not radio resource division is necessary when each of the at least one candidate carrier is used for the multi-carrier communication.

### (Supplementary Note 22)

The method according to Supplementary note 21, in which the information for determining whether or not the radio resource division is necessary includes information indicating an operation type of the relay station.

### (Supplementary Note 23)

A control method of a base station that performs a data transfer with a mobile station connected to the relay station via a first and second radio link, the first radio link being connected between the base station and the relay station, the second radio link being connected between the relay station and the mobile station, the method including:

transmitting carrier information to the relay station through a radio communication unit of the base station when the first radio link is in connection using a first carrier, the carrier information indicating at least one candidate carrier available for performing multi-carrier communication on the first radio link;

receiving request information about a configuration of the first radio link for each of the at least one candidate carrier from the relay station through the radio communication unit; and

determining, based on the request information, a second carrier used with the first carrier for the multi-carrier communication.

### (Supplementary Note 24)

The method according to Supplementary note 23, in which the request information includes information for determining whether or not radio resource division is necessary when each of the at least one candidate carrier is used for the multi-carrier communication.

### (Supplementary Note 25)

The method according to Supplementary note 24, in which the information for determining whether or not the radio resource division is necessary includes information indicating an operation type of the relay station.

### (Supplementary Note 26)

The method according to Supplementary note 24 or 25, in which the determining the second carrier includes determining a candidate carrier that does not require the radio resource division preferentially among the at least one candidate carrier as the second carrier.

### (Supplementary Note 27)

The method according to any one of Supplementary notes 24 to 26, in which the determining the second carrier includes determining, as the second carrier, a candidate carrier which does not require the radio resource division and whose radio resource usage ratio is lower than a predetermined reference level among the at least one candidate carrier.

### (Supplementary Note 28)

The method according to any one of Supplementary notes 23 to 27, in which the carrier information is transmitted from the base station to the relay station prior to a start of the multi-carrier communication and is included in setting information used for setting by the relay station to start the multi-carrier communication.

(Supplementary note 29)

A program that causes a computer to execute a method according to any one of Supplementary notes 20 to 22.

### (Supplementary Note 30)

A program that causes a computer to execute a method according to any one of Supplementary notes 23 to 27.

What is claimed is:

1. A mobile communication system comprising:
a base station; and
a relay station configured to perform a data relay between the base station and a mobile station by using a first radio link connected to the base station and a second radio link connected to the mobile station, wherein
the base station is configured to transmit carrier information to the relay station in response to a connection of the first radio link using a first carrier, the carrier information indicating at least one candidate carrier available for performing multi-carrier communication on the first radio link,
the relay station is further configured to transmit, to the base station, request information about a configuration of the first radio link for the at least one candidate carrier indicated by the carrier information, and
the base station is further configured to determine, in response to receiving the request information, a second carrier used with the first carrier for the multi-carrier communication.

2. The mobile communication system according to claim 1, wherein the request information includes information for determining whether or not radio resource division is to be used when the at least one candidate carrier is used for the multi-carrier communication.

3. The mobile communication system according to claim 2, wherein the information for determining whether or not the radio resource division is necessary includes information indicating an operation type of the relay station.

4. The mobile communication system according to claim 2, wherein the base station determines, as the second carrier, a candidate carrier, among the at least one candidate carrier, that does not require the radio resource division.

5. The mobile communication system according to claim 2, wherein the base station determines, as the second carrier, a candidate carrier, among the at least one candidate carrier, which does not require the radio resource division and whose radio resource usage ratio is lower than a predetermined reference level.

6. The mobile communication system according to claim 1, wherein the carrier information is transmitted from the base station to the relay station prior to a start of the multi-carrier communication and is included in setting information used for setting by the relay station to start the multi-carrier communication.

7. The mobile communication system according to claim 6, wherein
the base station is further configured to transmit an activation request for communication using the second carrier to the relay station, and
the relay station is further configured to activate the communication using the second carrier by using a communication setting corresponding to the second carrier indicated in the activation request among communication settings of the at least one candidate carrier held based on the setting information.

8. The mobile communication system according to claim 7, wherein
the base station is further configured to transmit to the relay station a release request for requesting a release of the communication setting of each of the candidate carrier except the second carrier, and
the relay station is further configured to release the communication setting of each of the candidate carrier except the second carrier in response to the release request.

9. The mobile communication system according to claim 6, wherein the base station is further configured to, in response to failing to determine the second carrier from the at least one candidate carrier, request the relay station to release the communication setting of the at least one candidate carrier and transmit to the relay station the setting information including carrier information indicating a new carrier different from the at least one candidate carrier.

10. The mobile communication system according to claim 1, wherein
the base station is further configured to transmit setting information about the second carrier to the relay station, and
the relay station is further configured to perform a setting operation to start the multi-carrier communication using the second carrier by referring to the setting information.

11. A relay station comprising:
a radio communication unit configured to perform a data relay between a base station and a mobile station by using a first radio link connected to the base station and a second radio link connected to the mobile station; and
a control unit configured to transmit, to the base station through the radio communication unit, request information about a configuration of the first radio link for at least one candidate carrier indicated by carrier information, the at least one candidate carrier being available for performing multi-carrier communication on the first radio link, the carrier information being transmitted from the base station in response to a connection of the first radio link using a first carrier.

12. The relay station according to claim 11, wherein the request information includes information for determining whether or not radio resource division is to be used when the at least one candidate carrier is used for the multi-carrier communication.

13. The relay station according to claim 12, wherein the information for determining whether or not the radio resource division is to be used includes information indicating an operation type of the relay station.

14. A base station comprising:
a radio communication unit configured to perform a data transfer with a mobile station connected to a relay station via a first and second radio link, the first radio link being connected between the radio communication unit and the relay station, the second radio link being connected between the relay station and the mobile station; and
a control unit configured to (i) transmit carrier information to the relay station in response to a connection of the first radio link using a first carrier, the carrier information indicating at least one candidate carrier available for performing multi-carrier communication on the first radio link, and (ii) determine, in response to receiving request information about a configuration of the first radio link for the at least one candidate carrier from the relay station, a second carrier used with the first carrier for the multi-carrier communication.

15. The base station according to claim 14, wherein the request information includes information for determining whether or not radio resource division is to be used when the at least one candidate carrier is used for the multi-carrier communication.

16. The base station according to claim 15, wherein the information for determining whether or not the radio resource division is to be used includes information indicating an operation type of the relay station.

17. The base station according to claim 15, wherein the control unit is further configured to determine, as the second carrier, a candidate carrier, among the at least one candidate carrier, that does not require the radio resource division.

18. The base station according to claim 15, wherein the control unit is further configured to determine, as the second carrier, a candidate carrier, among the at least one candidate carrier, which does not require the radio resource division and whose radio resource usage ratio is lower than a predetermined reference level.

19. The base station according to claim 14, wherein the carrier information is transmitted from the base station to the relay station prior to a start of the multi-carrier communication and is included in setting information used for setting by the relay station to start the multi-carrier communication.
